(19) United States
(12) Patent Application Publication
(10) Pub. No.: US 2007/0186462 A1
(43) Pub. Date: Aug. 16, 2007

(54) Castable crab trap

(76) Inventor: Joseph Eichensehr, Pacifica, CA (US)

Correspondence Address: Joseph Eichensehr, 436 Glasgow Dr., Pacifica, CA, 94044, US

(21) Appl. No.: 11/645,957

(22) Filed: Dec. 28, 2006

Related U.S. Application Data
(60) Provisional application No. 60/756,188, filed on Jan. 5, 2006.

(51) Int. Cl. A01K 69/06; A01K 69/00

(52) U.S. Cl. 43/100; 43/103

(57) ABSTRACT

A castable crab trap having a rectangular body formed of a welded wire material, a bait compartment in the rectangular body, and a series of looped snares which close about the leg or claw of the crab when the trap is lifted. The openings in the welded wire are sized to allow the crab to partially insert its claw into the bait compartment.

### CROSS-REFERENCE TO RELATE APPLICATIONS

None

### FEDERALLY SPONSORED RESEARCH

None

### SEQUENCE LISTING

None

### BACKGROUND

This invention provides an improved crab trap. Crabs have long been considered a delicacy by many people. It turns out that crabs inhabit numerous tidal waters which can be readily accessed from the shore, bridges, docks, or small boats. This fortunate happenstance, along with the crab's propensity to feed on many types of flesh and artificial baits, has sparked the invention of numerous crab traps designed to enable crab lovers to more readily harvest their prize.

Crab traps of the type most pertinent to the present invention are disclosed in U.S. Pat. No. 5,174,059 to Durbin; U.S. Pat. No. 5,157,864 to Kuroda et al; U.S. Pat. No. 4,697,381 to Esgro et al; U.S. Pat. No. 4,271,625 to Archer; to Lyster; and U.S. Pat. No. 3,185,276 to Harrison. The crab traps disclosed in each of those patents rely on flexible loops of fishing line to snare one or more legs of the crab. In each instance, the crab is lured to the ensnaring loops by a bait which is affixed to the trap. In the traps disclosed in Kuroda et al, Lyster, and Harrison, the bait is impaled on a fish hook or a bait rod. In Esgro et al and Archer, the bait is held by a loop or otherwise tied to a central frame member of the trap. In Durbin, the bait is contained within a rigid central wire cage. The wire cage has upper and lower halves which are held together by a central axial bolt and nut.

A need remains therefore, for a sturdier, better designed and constructed crab trap which is capable of more reliably catching this tasty crustacean, and which renders academic the extreme distress which normally accompanies any failure to satiate a hopeful crab lover's appetite.

This invention relates to crab traps, specifically to castable traps with snares that are attached to a fishing pole. These allow users to fish for fresh or salt water crustaceans while using less bait and not having the burden of lifting a heavy apparatus. Crab pots and nets are heavy and cumbersome, especially when fishing off of tall piers. They must be checked several times an hour, which means that the crabber must haul in a heavy 10 to 15 pound metal and rope net to make sure that the crab haven't eaten the bait and walked away. It is a die hard crabber that is willing to do this much lifting over the course of a “leisurely” fishing outing! Crabbing is largely a matter of attracting crab with bait without loosing too much of the bait in the process as well as ensnaring the crab before it looses interest and walks away. Existing methods of attracting and catching crab are less productive. The Danielson Crab Snare of Auburn, Wash. is one such example. The door has a tendency to fall off. The hinges on the Castable Crab Trap are much more secure and won't fall apart. The loops on the Danielson Crab Snare have several disadvantages. After catching a crab, the loops have a tendency to stay closed and must each me manually opened before casting again. In addition, the loops stay tightly closed on the crabs claws and must be carefully loosened after a catch. The looping design and materials used on the Castable Crab Trap loosen when any tension is released. The cube shape of the Danielson Crab Snare hinders it from casting very far out. The streamlined, rectangular shape of the Castable Crab Trap enables it to cast twice as far. In addition, the castable Crab Trap uses less bait to equally attract crab. The band used to hold the door shut on the Castable Crab Trap is made of more durable material. The Danielson Crab Snare uses a band the quickly gets brittle in salt water. The smaller, rectangular shape of the Castable Crab Trap fits into a tackle box more efficiently. The Danielson Crab Snare is made and sold with seven loops. The unwary consumer will use this product, oblivious to the fact that in some states, (i.e., California) only six loops are allowed. This can result in a hefty fine. In addition, sea lions have tended to leave the Castable Crab Trap alone. It is thought that they have learned that the doors just cannot be opened by them.

### SUMMARY OF THE INVENTION

The present invention is embodied in a lighter, more reliable crab trap comprising an upper frame member, a bait compartment defined by a first portion of welded wire and a series of snares around the perimeter. The welded wire has openings sized to allow a crab to insert one “finger” of its claw only part way into the bait compartment.

### DRAWINGS

FIG. 1 is a perspective side view of a castable crab trap constructed in accordance with the invention. This view is before the snares are attached.

FIG. 2 is a perspective view of the trap taken from above. This view shows the completed trap.

### DETAILED DESCRIPTION

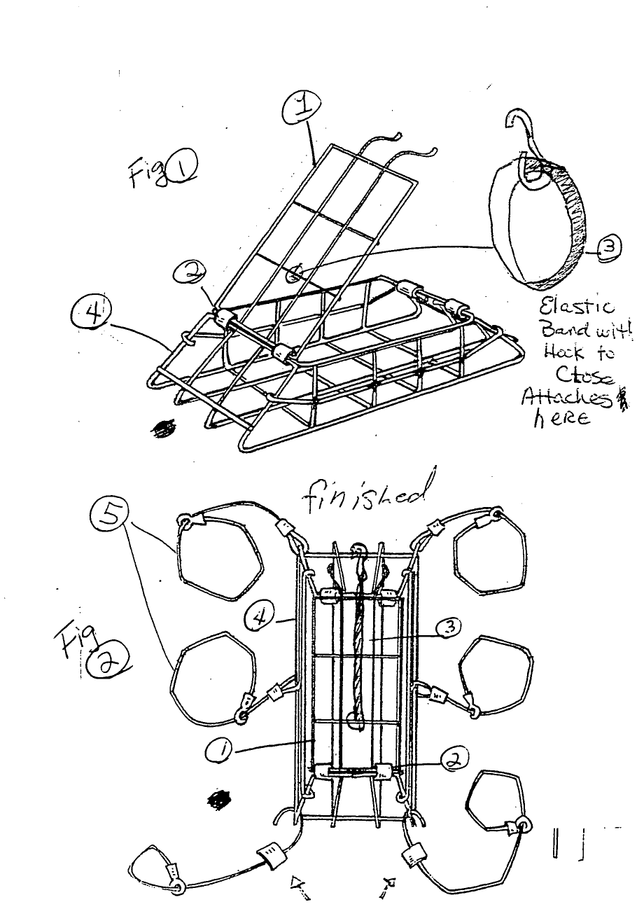

FIG. 1 is a perspective side view of the side of a trap (4) constructed in accordance with the invention. The door of the trap is attached with metal clips to form a hinge (2). The door (1) has a stretchable elastic band with an attached metal hook (3) to ensure that the door of the trap stays closed when filled with bait.

FIG. 2 is a perspective top view of the completed trap, showing the snares attached equally distanced around the perimeter of the trap as well as the closed and fastened door.

### REFERENCE NUMERALS

(1) door
(2) hinge
(3) elastic band with hook
(4) trap body
(5) snares

Operation

In operation, the user firmly fills the trap with appropriate bait. Additional lead weights may be inserted into the trap if conditions warrant it. Secure the door with the hook. Attach fishing line to the non-hinge side of the trap. Cast out the trap and let is settle on the bottom of the body of water. I is recommended to leave the trap undisturbed for 8 to 12 minutes. Alternately, the user can observe the tip of the fishing rod for any shaking, indicating that something is feeding on the bait in the trap. Pull back on the rod and smoothly reel in the trap, always keeping tension on the fishing line. If the tension is relaxed, this will slacken the snares and allow the crab to escape. When the crab is reeled in, set is down on the beach/pier and relax the tension. The snares will then relax and the crab will walk out of them. Now the user can simply pick up their crab and place in a holding pail. The design eliminates the need to get in close to a crabs' claws and untangle or loosen it from the snares.

I claim:

1. An improved crab trap comprising:
A rectangular member formed of a welded wire material, rectangular member having a bait compartment; an opening formed in the bait compartment for receiving bait and a door engaged with the rectangular member and operable to cinch the bait compartment opening;
A snare comprising a line having a first end portion connected to the rectangular member, and a second end portion slidably connected to the central portion.

2. A crab trap according to claim 1 further comprising a plurality of snares, and each said snare having a first end portion connected to the crab trap and a second end portion slidably connected to the central portion.

3. A crab trap according to claim 1 wherein the welded wire material is selected to have openings sized to receive a crab's claw.

4. A crab trap according to claim 1 further comprising a plurality of snares, each said snare having a first end portion connected to an upper portion of the crab trap and a second end portion slidably connected to a lower portion of the crab trap.

5. A crab trap according to claim 2 wherein the welded wire material is selected to have openings sized to receive a crab's claw.
